(19) United States
(12) Patent Application Publication
(10) Pub. No.: US 2009/0084961 A1
(43) Pub. Date: Apr. 2, 2009

(54) RADIATION DETECTOR

(76) Inventors: Junichi TONOTANI, Yokohama-shi (JP); Masatoshi HIGUCHI, Kawasaki-shi (JP); Keiko SAKAI, Yamato-shi (JP); Katsuhisa HOMMA, Kuki-shi (JP); Atsuya YOSHIDA, Nasushiobara-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/236,884

(22) Filed: Sep. 24, 2008

(30) Foreign Application Priority Data
Sep. 28, 2007 (JP) 2007-255653
Sep. 12, 2008 (JP) 2008-235346

(51) Int. Cl. G01T 1/20

(52) U.S. Cl. 250/361 R

(57) ABSTRACT

A radiation detector includes an electrode substrate having plural photoelectric transfer elements which convert visible light into electrical signals, a scintillator layer formed on the electrode substrate and converting radial rays into visible light, and a protective film includes a drying agent film and a moisture-proof film. The drying agent film is formed on at least the scintillator layer. The moisture-proof film is formed on the drying agent film.

### CROSS-REFERENCE TO RELATED APPLICATIONS

This application is based upon and claims the benefit of priority from prior Japanese Patent Applications No. 2007-255653, filed Sep. 28, 2007; and No. 2008-235346, filed Sep. 12, 2008, the entire contents of both of which are incorporated herein by reference.

### BACKGROUND OF THE INVENTION

1. Field of the Invention

The present invention relates to a radiation detector that converts incident radial rays into electrical signals.

2. Description of the Related Art

The active matrix type plane detector has been developed as the X-ray diagnosis image detector in the new generation. In this plane detector, radiated X-rays are detected to output an X-ray photographic image or a realtime X-ray image as digital signals.

This type of plane detector is largely classified into two systems, that is, a direct system and an indirect system. The direct system is a system in which X-rays are directly converted into charge signals using an X-ray transforming film to obtain an image. On the other hand, the indirect system is a system in which X-rays are converted into visible light in a scintillator layer and then, the visible light is converted into charge signals by using a photoelectric transfer element such as an amorphous silicon (a-Si) photodiode or CCD to obtain an image.

For the scintillator layer to be incorporated into the plane detector used in the indirect system, materials such as cesium iodide:sodium (CsI:Na), cesium iodide:thallium (CsI:Tl), sodium iodide (NaI) and acidic gadolinium sulfide (Gd₂O₂S) are used. This scintillator layer is made into a cylindrical form either by forming a channel by dicing or the like or by depositing to form a cylindrical structure. The scintillator layer having such a cylindrical structure is improved in resolution characteristics. However, many of the above materials used as the scintillator layer exhibit a high moisture-absorbing property. For this, the scintillator layer is degraded in sensitivity characteristics and resolution characteristics when it is allowed to stand in an air atmosphere.

In light of this, studies are made to form a protective film having the ability of shielding air and moisture and X-ray transmittance on a scintillator layer of an indirect system plane detector, thereby preventing the deterioration in the characteristics of the scintillator layer. In, for example, Jpn. Pat. Appln. KOKOKU Publication No. 5-39558, there is disclosed a method in which an organic film such as a xylylene type resin film formed by vapor deposition method under vacuum or in an inert gas atmosphere is used as a moisture-proof film. Besides, it is known that a polyparaxylylene film or epoxy resin film is used as a moisture-proof film. Also, in Jpn. Pat. Appln. KOKOKU Publication No. 6-58440, there is disclosed that an inorganic film such as a silicon oxynitride film is used as a moisture-proof film.

### BRIEF SUMMARY OF THE INVENTION

According to a first aspect of the present invention, there is provided a radiation detector comprising:
an electrode substrate having plural photoelectric transfer elements which convert visible light into electrical signals;
a scintillator layer formed on the electrode substrate and converting radial rays into visible light; and
a protective film comprising a drying agent film and a moisture-proof film, the drying agent film being formed on at least the scintillator layer, and the moisture-proof film being formed on the drying agent film.

According to a second aspect of the present invention, there is provided a radiation detector comprising:
an electrode substrate having plural photoelectric transfer elements which convert visible light into electrical signals;
a scintillator layer formed on the electrode substrate and converting radial rays into visible light; and
a moisture-proof film formed on at least the scintillator layer and being dispersed drying agent.

### BRIEF DESCRIPTION OF THE SEVERAL VIEWS OF THE DRAWING

FIG. 1 is a sectional view of an essential part showing an X-ray detector according to an embodiment of a present invention;

FIG. 2 is a view showing the moisture-absorbing characteristics of a scintillator layer of CsI;

FIG. 3 is a view showing the moisture-absorbing characteristics of a drying agent film of Test Example 2 which is constituted of a mixture of alkoxyaluminum and a silicon-containing polymer and a drying agent film of Comparative Example 1 which is constituted only of alkoxyaluminum; and

FIG. 4 is a view showing the relationship between the time and the resolution retentive rate when sample of Test Example 3 and a sample of Comparative Example 2 exposed to a circumstance of 60° C. and 90% humidity, respectively.

### DETAILED DESCRIPTION OF THE INVENTION

An X-ray detector according to an embodiment of the present invention will be explained in detail with reference to the drawings.

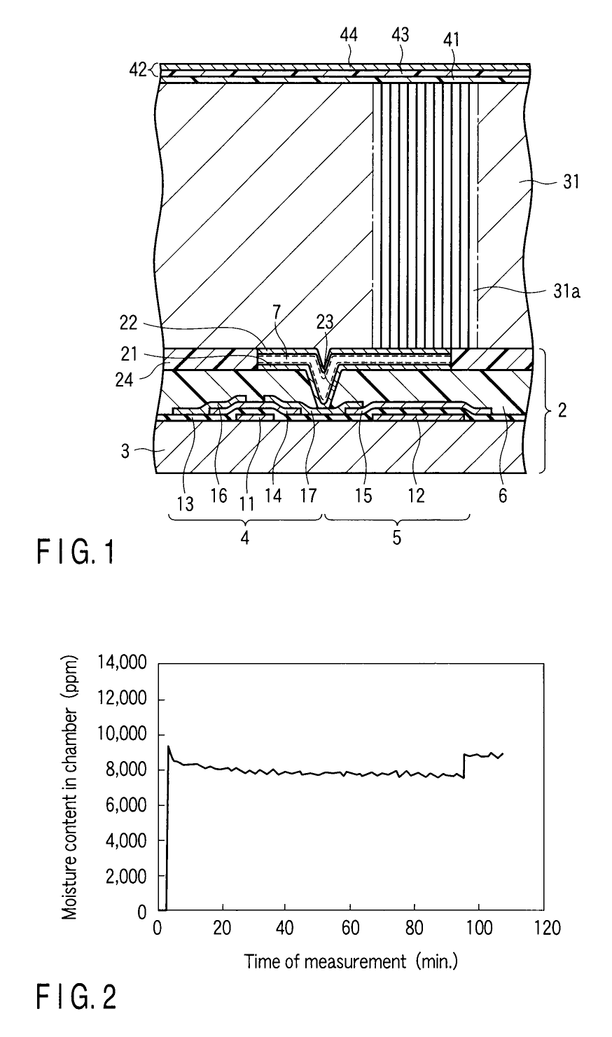

FIG. 1 is a sectional view of an essential part showing an indirect transfer system X-ray detector according to the embodiment.

An indirect transfer system X-ray detector 1 is provided with an active matrix photoelectric transfer substrate 2 which is an electrode substrate. The photoelectric transfer substrate 2 is provided with a glass plate 3 (translucent plate) made of Corning 1737 (trade name, manufactured by Corning Incorporated), plural thin film transistors 4 as switching elements and plural rectangular plate-like storage capacitors 5 which are formed matrix-wise on one main surface of the glass plate 3, an insulation flattened resin layer 6 formed on these thin film transistors 4 and the storage capacitor 5 and a photoelectric transfer element, for example, a photodiode 7, which converts visible light into electrical signals and is formed on the flattened resin layer 6 so as to be connected with the thin film transistor 4.

The thin film transistor 4 is provided with a gate electrode 11 formed on the glass plate 3 and the storage capacitor 5 is provided with a first electrode 12 formed on the glass plate 3. An insulation film 13 doubling as a gate insulation film and a dielectric film is formed on the entire surface of the glass plate 3 including the electrodes 11 and 12. For example, an active layer 14 made of impurity dope polycrystal silicon is formed on the insulation film 13 so as to be opposite to the gate electrode 11. A second electrode 15 made of metal or indium-tin oxide(ITO) is formed on the insulation film 13 so as to be opposite to the first electrode 12. A source electrode 16 is formed on the insulation film 13 in such a manner as to be overlapped on one end (for example, left end) of the active layer 14. A drain electrode 17 is formed on the insulation film 13 in such a manner as to be overlapped on the other end (for example, right end) of the active layer 14 and on one end (for example, left end) of the second electrode 15. The flattened resin layer 6 is formed on the entire surface of the insulation film 13 including the active layer 14, the second electrode 15, the source electrode 16 and drain electrode 17.

The photodiode 7 is formed on the flattened resin layer 6 in the form of a pn diode structure or pin diode structure of amorphous silicon (a-Si) in each pixel. The photodiode 7 is provided with a current collecting electrode 21 which is a first electrode and a bias electrode 22 made of indium-tin oxide (ITO) for example as a second electrode. The current collecting electrode 21 is connected with the drain electrode 17 through a through-hole 23 of the flattened resin layer 6. A bias electric field is formed between the bias electrode 22 and the current collecting electrode 21 by applying bias voltage. An insulation resin layer 24 is formed on the same flat as the bias electrode 22 on the flattened resin layer 6 excluding the photodiode 7, current collecting electrode 21 and bias electrode 22.

A high-speed signal processing section (not shown) having a lengthy rectangular plane form which controls the action of each thin-film transistor 4, for example, the on-off action of each thin-film transistor 4 is attached to one side edge along the direction of the line on the surface of the glass plate 3. This high-speed signal processing section is a line driver that, for example, controls the reading of signals and treats the read signals. Each one end of plural control lines (not shown) is electrically connected to the high-speed signal processing section. Each control line is wired along the direction of the line of the glass substrate 3 so as to be positioned between pixels. Also, each control line is electrically connected to gate electrode 11 of the thin-film transistor 4 constituting each pixel on the same line.

On the surface of the glass plate 3, plural data lines (not shown) are wired along the direction of the column so as to be positioned between pixels. Each data line is electrically connected to source electrode 16 of the thin-film transistor 4 constituting pixels on the same column and receives image data signals from the thin-film transistor 4 constituting pixels on the same column. One end of each data line is electrically connected to the high-speed signal processing section and, further, the high-speed signal processing section is electrically connected to a digital image transfer section (not shown) used as a digital image processing section. This digital image transfer section is attached in such a manner as to be led out of the photoelectric transfer substrate 2.

A scintillator layer 31 that converts incident X-rays into visible light is formed on the insulation resin layer 24 including the bias electrode 22. This scintillator layer 31 is a cylindrical crystal constituted by depositing a fluorescent body such as sodium iodide (NaI) or cesium Iodide (CsI) on an individual cylindrical structure 31a by using, for example, the vapor deposition method, electro-beam method or sputtering method. Accordingly, the scintillator layer 31 is reduced in the diffusion of the light generated by the cylindrical crystal and has high resolution.

A reflection film 41 is formed on the surface of the scintillator layer 31 in the embodiment. However, the reflection film 41 is not always essential. The reflection film 41 reflects the light propagating towards the side opposite to the photoelectric transfer element among the fluorescent light emitted from the scintillator layer 31, in the direction of the photoelectric transfer element, thereby improving utilization efficiency of scintillator emission. This effect improves the sensitivity required for the radiation detector. In the meantime, the propagation distance of the light reflected on the reflection film 41 to the photoelectric transfer element is made long and accordingly the light is more broadened than the direct light going directly to the photoelectric transfer element from the scintillator layer 31. For this reason, there is a fear that this brings about a reduction in resolution along with the increase in sensitivity. The protective film 42 is formed on the reflection film 41. The protective film 42 is provided with a drying agent film 43 and a moisture-proof film 44. Namely, the drying agent film 43 is formed on the reflection film 41. The moisture-proof film 44 is formed on the drying agent film 43.

The reflection film 41 can be used a composition consisting of a thermoplastic macromolecular compound such as a butyral resin, polyester resin or acryl resin and a titanium oxide powder containing in thermoplastic macromolecular compound with an amount of 70% by weight or more base on the composition.

The drying agent film 43 is made a mixture of an alkoxide of the Group II, Group III or Group IV metal and an organic polymer.

As the metal alkoxide, for example, aluminum alkoxide may be used. Examples of the aluminum alkoxide may include OleDry-L3 (trade name, manufactured by Futaba Corporation, containing 25 wt % decane solvent).

The organic polymer is preferably a silicon-containing polymer and more preferably a silicon-containing polymer having a silyl group. As such a silicon-containing polymer, a copolymer of 30 to 35 mol % of methylhydrosiloxane and 65 to 70 mol % of dimethylsiloxane may be used. The organic polymer is preferably contained in an amount of 25 to 70% by volume based on the above mixture. A drying agent film constituted of such a mixture may be formed by, for example, the coating method in which a solution obtained by dissolving the above mixture in a solvent is applied.

Also, the drying agent film 43 may be made of a material such as calcium oxide, magnesium oxide, calcium or magnesium besides the above mixture. Such a drying agent film may be formed by the vapor deposition method.

The moisture-proof film 44 is preferably made of a material which (a) transmits X-rays, (b) is reduced in water permeability and (c) is inert to the drying agent film. As such a moisture-proof film 43, inorganic vapor deposition films such as a silicon nitride film, silicon oxynitride film, silicon oxide film, alumina film and aluminum nitride film or a polyparaxylene film formed by, for example, vapor deposition may be used. Besides the above materials, a metal film such as an aluminum film of 100 nm to 100 μm in thickness may be used as the moisture-proof film.

The action of the indirect X-ray detector having the structure shown in FIG. 1 will be explained.

When X-rays are made to be incident to the scintillator layer 31 through the moisture-proof film 44, drying agent film 43 and a reflection film 41, they generates visible light in the scintillator layer 31. Visible light is radiated towards the reflection film 41 side and photodiode 7 side. The visible light incident to the reflection film 41 is reflected and emitted towards the photodiode 7. Visible light is allowed a photoelectric conversion by the photodiode 7. At this time, bias voltage is applied to the upper side bias electrode 22 through the photodiode 7 to allow the current collector electrode 21 to generate a bias electric field, whereby the charges (signal charges) generated in the photodiode 7 are transferred to the current collector electrode 21, then transferred from the current collector electrode 21 and stored in the storage capacitor 5 via the drain electrode 17 and the like.

On the other hand, the signal charges stored in the storage capacitor 5 are read, for example, sequentially every line of a pixel unit under control in a high-speed signal processing section (not shown).

Specifically, for example, a 10V on-signal is input to each gate electrode 11 of a pixel unit positioned on a first line through a data line (not shown) from the high-speed signal processing section to put each thin film transistor 4 of a pixel unit positioned on the first line to an on-state. When the thin film transistor 4 is turned on, signal charges stored in the storage capacitor 5 of the fist line pixel unit are output as electrical signals to the source electrode 16 from the drain electrode 17. The electrical signals output to the source electrode 16 are amplified respectively by the high-speed signal processing section. The amplified electrical signals are output to a digital image transfer section (not shown), converted into serial signals, further converted into digital signals and fed to a signal processing circuit (not shown) in the next stage.

When the reading of the charges in the storage capacitor 5 of the pixel unit positioned on the first line is finished, for example, a −5V off-signal is input to each gate electrode 11 of the pixel unit positioned on the first line through a data line from the high-speed signal processing section to put each thin film transistor 4 of the pixel unit positioned on the first line to an off-state.

After that, as to pixel units positioned on the second or more lines, the foregoing operations are carried out one after another. Signal charges stored in the storage capacitors 5 of all the pixel units are read, sequentially converted into digital signals and output, to thereby output electrical signals corresponding to one X-ray image plane from a digital image transfer section (not shown).

According to this embodiment, as is explained above, the drying agent film 43 and the moisture-proof film 44 are laminated in this order on the reflection film 41 formed on the electrode substrate (photoelectric transfer substrate) 2 including the scintillator layer 31 to form a protective layer 42. Therefore, it is possible to prevent the penetration of moisture into the scintillator layer 31. That is, even if moisture which passes through the moisture-proof film 44 itself or penetrates from the interface at which the scintillator 31 is in closed contact with the moisture-proof film 44 is present, the moisture is absorbed by the drying agent film 43 disposed underneath to be able to prevent the scintillator layer 31 from reacting with moisture.

Particularly, if the drying agent film 43 is made of a mixture of an alkoxide of a specified metal and an organic polymer, an excellent moisture-absorbing ability can be maintained, thereby being able to prevent the penetration of moisture into the scintillator layer 31 more exactly.

It was, in fact, confirmed in the following experiments that a drying agent film constituted of the mixture had excellent moisture-absorbing ability.

### TEST EXAMPLE 1

A closed container provided with a gas introduction port and a dew-point sensor was prepared. CsI was formed as a film on a non-alkaline glass plate which was 4 cm×4 cm square by the vapor deposition method. This glass plate was placed in the closed container kept in an atmosphere including H₂0 in a concentration less than 1 ppm. Then, the gas introduction port was opened to introduce air including moisture in a little amount and then closed again to measure a variation in dew point with time, thereby investigating the moisture-absorbing characteristics of the scintillator layer. The results are shown in FIG. 2.

From FIG. 2, the amount of water to be absorbed is 0.2 mg which is calculated and estimated from the equation of state of ideal gas on the premise that CsI perfectly absorbs water when a variation in dew point is saturated and the dew point is fixed. It is found from this result that the CsI scintillator layer has high moisture-absorbing ability.

### TEST EXAMPLE 2

A mixture obtained by mixing alkoxyaluminum (trade name: OleDry-L3, manufactured by Futaba, Corporation, including 25 wt % decane solvent) and a thermally dehydrated product of a silicon-containing polymer (trade name: HMS-301, manufactured by Gelest Inc., a copolymer of 30 to 35 mol % of methylhydrosiloxane and 65 to 70 mol % of dimethylsiloxane) in a ratio by volume of 70 to 30 was prepared as a coating type drying agent (Test Example 2).

Only alkoxyaluminum (trade name: OleDry-L3, manufactured by Futaba Corporation, including 25 wt % decane solvent) was prepared as a coating type drying agent (Comparative Example 1).

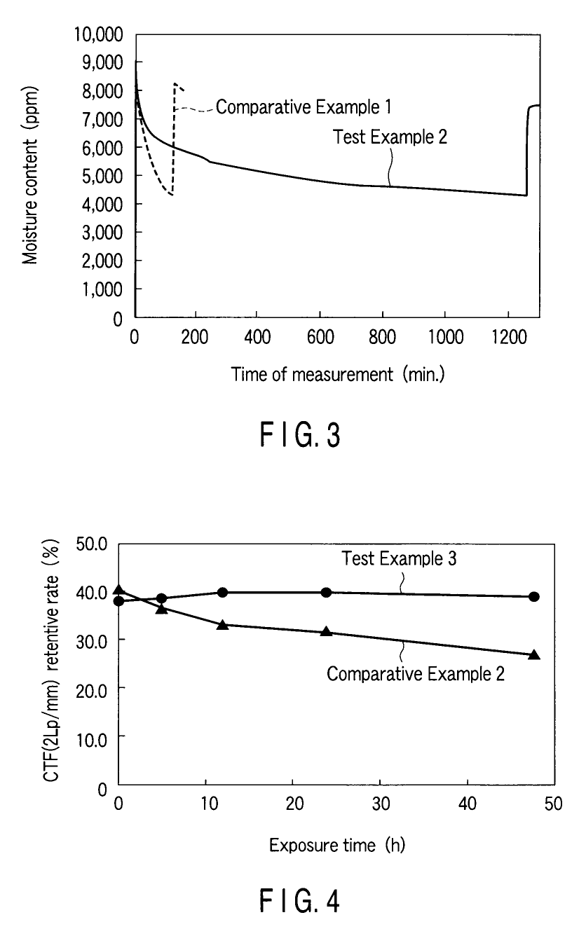

The coating type drying agents obtained in Test Example 2 and Comparative Example 1 were respectively applied to a glass plate to form a drying agent film to examine the moisture-absorbing ability of the drying agent film. The results are shown in FIG. 3.

It is found from FIG. 3 that each drying agent film obtained in Test Example 2 and Comparative Example 1 has a moisture-absorbing amount of 0.96 mg and therefore has higher moisture-absorbing ability than the CsI scintillator layer.

However, it has been confirmed from a microscopic examination that the drying agent film of Comparative Example 1 produces cracks after moisture is absorbed. This is considered to be because when alkoxyaluminum which is a component of the drying agent absorbs moisture, it is converted into aluminol and is therefore reduced in molecular weight, causing stress in the film, leading to the formation of cracks. When such cracks are formed, moisture penetrates through the cracks portion causing a deterioration of the scintillator layer of the X-ray detector.

On the other hand, the drying agent film of Test Example 2 in which a silicon-containing polymer is mixed is not changed in the amount of moisture absorbed in total though it is degraded in moisture-absorbing rate and therefore, not only maintains water-absorbing ability but also is decreased in stress in the film, so that the formation of cracks can be prevented.

As mentioned above, it has been clarified that a drying agent film constituted of a mixture of alkoxyaluminum and a silicon-containing polymer is not degraded in the ability as a drying agent and also, forms no crack caused by moisture absorption, making it possible to maintain excellent moisture-absorbing ability for a long period of time.

Accordingly, an X-ray detector can be provided which can prevent the penetration of moisture into the scintillator layer 31, limit the deterioration of the scintillator layer 31 in the acceleration test under high-temperature and high-humidity conditions to thereby prevent reductions in resolution and luminous efficacy and maintain high sensitivity characteristics and resolution characteristics for a long period of time.

Next, the resolution of a scintillator layer provided with a protective film prepared by laminating the drying agent film and the moisture-proof film in this order was evaluated by the following Test Example 3.

### TEST EXAMPLE 3

In Test Example 3, a sample was prepared which was fitted to the purpose of comparing deterioration in the resolution of the scintillator layer based on whether the drying agent film was present or not. That is, a CsI:Tl vapor deposition film of 600 μm in thickness as the scintillator layer was formed on a glass substrate. The protective film on the scintillator layer had a three-layer structure in which a first moisture-proof film made of a polymonochloroparaxylylene (pallilene c), a drying agent film and a second moisture-proof film made of the same material as the first moisture-proof film were formed in this order.

This protective film was formed by the following method. First, the first moisture-proof film of 5 μm in thickness made of a polymonochloroparaxylylene (pallilene c) was formed directly on the scintillator layer 31 made of CsI as shown in FIG. 1 by the chemical vapor deposition method. Subsequently, a mixture was applied to the first moisture-proof film and baked at 150° C. for 15 minutes to form a drying agent film. The mixture was obtained by mixing alkoxyaluminum (trade name: OleDry-TO49, manufactured by Futaba Corporation) and a thermally dehydrated product of a silicon-containing polymer (trade name: HMS-301, manufactured by Gelest, a copolymer of 30 to 35 mol % of methylhydrosiloxane and 65 to 70 mol % of dimethylsiloxane) in a ratio by volume of 50:50. Further, a 20-μm-thick second moisture-proof film made of polymonochloroparaxylylene (pallilene c) was formed on the drying agent film by the chemical vapor deposition method.

Also, a sample of Comparative Example 2 had a structure in which a 600-μm-thick CsI:Tl vapor deposition film as the scintillator layer was formed on a glass substrate and a 25-μm-thick moisture-proof film made of polymonochloroparaxylylene (pallilene c) was formed on the scintillator layer. In other words, in the sample of Comparative Example 2, no drying agent was interposed between the moisture-proof films.

Each of the samples prepared in Test Example 3 and Comparative Example 2 was exposed to an atmosphere of 60° C. and 90% humidity to measure the resolution by the following method.

With regard to the resolution, each of samples was set in the following test device and measured. That is, the sample was supported on a holder such that the moisture-proof film of the sample was positioned on the top surface. An X-ray tube serving as an X-ray source was disposed above the holder in such a manner that the interface between the scintillator layer of the sample and the glass substrate was 1.0 m distant from the X-ray emission portion. An X-ray filter made of an aluminum thin film of 1.5 mm in thickness was disposed in the vicinity of the X-ray tube between the holder and the X-ray tube. A resolution chart was is positioned between the holder and the X-ray tube and being disposed about 5 mm apart from the interface between the scintillator layer of the sample and the glass substrate. Here, the resolution chart had a 2 Lp/mm arrangement structure in which two lines and two spaces having the same width were arranged in each space of 1 mm in width. A CCD camera with a tandem lens attached to the tip thereof was disposed on the backside of the holder.

In such a test device, the X-ray tube was operated in the condition of 70 kV-1 mA to irradiate the sample with X-rays through the X-ray filter and the resolution chart and to convert the transmitted X-rays into an optical image in the scintillator layer. A photograph of this optical image was taken by the CCD camera to obtain a resolution chart image. The CCD camera was focused on the interface between the scintillator layer of the sample and the glass substrate. This is because this process prevents an image from being blurred by the glass substrate to take a 2 Lp/mm resolution chart image. Subsequently, the resolution chart disposed between the holder and the X-ray tube was removed to take a photograph of an X-ray image in the same manner. This X-ray image and the X-ray image obtained when the resolution chart was disposed were subjected to, for example, division treatment to calibrate the brightness unevenness of the measuring sample itself. From the contrast between light and shade of the calibrated resolution chart image, 2 Lp/mm contrast transfer function (CTF) which was a quantitative index of the resolution was calculated. Based on the obtained results of the resolution, variations in resolution with time as a function of exposure time are shown in FIG. 4.

As is clear from FIG. 4, it was confirmed that no deterioration in the resolution of the sample of Test Example 3 which was provided with the protective film obtained by laminating the moisture-proof film and the drying agent film was observed even after the sample was exposed to a high-temperature and high humidity atmosphere for 48 hours, and therefore, high resolution could be maintained.

It should be noted that the protective film is not limited to the aforementioned two-layer structure in which the drying agent film and the moisture-proof film are laminated in this order or to the aforementioned three-layer structure in which the first moisture-proof film, the drying agent film and the second moisture-proof film are laminated in this order but may be a moisture-proof film prepared by dispersing a drying agent. Also, the drying agent film and the drying agent dispersing film each unnecessarily have a form of a continuous film but may have a form of an intermittent film or partial film.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A radiation detector comprising:
an electrode substrate having plural photoelectric transfer elements which convert visible light into electrical signals;
a scintillator layer formed on the electrode substrate and converting radial rays into visible light; and
a protective film comprising a drying agent film and a moisture-proof film, the drying agent film being formed on at least the scintillator layer, and the moisture-proof film being formed on the drying agent film.

2. The radiation detector according to claim 1, wherein the drying agent film is made of a mixture of an alkoxide of the Group II, Group III or Group IV metal and an organic polymer.

3. The radiation detector according to claim 2, wherein the organic polymer is a silicon-containing polymer.

4. The radiation detector according to claim 3, wherein the silicon-containing polymer is a copolymer of 30 to 35 mol % of methylhydrosiloxane and 65 to 70 mol % of dimethylsiloxane.

5. The radiation detector according to claim 2, wherein the organic polymer is contained in an amount of 25% by volume or more in the mixture.

6. The radiation detector according to claim 1, wherein the drying agent film is made of a material selected from the group consisting of calcium oxide, magnesium oxide, calcium or magnesium.

7. The radiation detector according to claim 1, wherein the moisture-proof film is made of one compound selected from the group consisting of a polyparaxylene, silicon nitride, silicon oxynitride, silicon dioxide or aluminum nitride.

8. The radiation detector according to claim 1, wherein the protective film further comprises a moisture-proof film formed between the scintillator layer and the drying agent film.

9. A radiation detector comprising:
an electrode substrate having plural photoelectric transfer elements which convert visible light into electrical signals;
a scintillator layer formed on the electrode substrate and converting radial rays into visible light; and
a moisture-proof film formed on at least the scintillator layer and being dispersed drying agent.
